(19) United States
(12) Patent Application Publication
(10) Pub. No.: US 2019/0308477 A1
(43) Pub. Date: Oct. 10, 2019

(54) LEAF SPRING HOLDER FOR CONNECTING A LEAF SPRING TO AN AXLE AND CHASSIS WITH SUCH A LEAF SPRING HOLDER

(71) Applicant: ZF Friedrichshafen AG, Friedrichshafen (DE)

(72) Inventor: Clemens HACKER, Osnabrück (DE)

(21) Appl. No.: 16/374,978

(22) Filed: Apr. 4, 2019

(30) Foreign Application Priority Data
Apr. 6, 2018 (DE) 10 2018 205 220.4

(51) Int. Cl. B60G 11/113; B60G 13/00; F16F 1/368

(52) U.S. Cl. CPC B60G 11/113; B60G 11/465; F16F 1/3683; B60G 13/005

(57) ABSTRACT

A leaf spring holder for connecting a leaf spring to an axle via a first fixing device and a second fixing device. Due to co-operation of the first fixing device with the second fixing device, a first mounting is spaced away from a second mounting to provide space for mounting the leaf spring between the first fixing device and the second fixing device. Co-operation of the first fixing device with the second fixing device enables deformation of a leaf spring section of the leaf spring between the first mounting and the second mounting. In order to increase the rigidity as a function of the spring deflection and/or to produce a rising-rate suspension, the leaf spring holder includes a stop surface for limiting deformation of the leaf spring section.

This application claims priority from German patent application serial no. 10 2018 205 220.4 filed Apr. 6, 2018.

### FIELD OF THE INVENTION

The invention relates to a leaf spring holder for connecting a leaf spring to an axle, having a first fixing device and a second fixing device, wherein by virtue of co-operation of the first fixing device with the second fixing device, a first mounting and a second mounting some distance away from the first mounting are produced in order to mount the leaf spring between the first fixing device and the second fixing device, and the co-operation of the first fixing device with the second fixing device enables deformation of a leaf spring section of the leaf spring between the first mounting and the second mounting. In addition, the invention relates to a chassis with such a leaf spring holder.

### BACKGROUND OF THE INVENTION

Such a leaf spring holder is known from WO 2017/027516 A1. In that case the leaf spring is formed as a single-leaf spring made from a fiber-plastic composite. Leaf springs made from a fiber-plastic composite, in particular a glass-fiber plastic, have great weight-saving potential compared with leaf springs made of metal. However, with leaf springs of a fiber-plastic composite or of a glass-fiber plastic there is a risk of damage, for example if dirt particles abrade the surface of the leaf spring. This makes the use of leaf springs having a plurality of leaves more difficult if the leaf springs are to be made from a fiber-plastic composite or from a glass-fiber plastic.

In the case of metallic leaf springs it is known to make these from a plurality of leaves, such that at least one of the leaves only engages or acts from a certain or predetermined spring deflection onward, whereby the rigidity of the leaf spring is increased. A leaf spring rigidity and/or rising-rate suspension that increases in this way is, for example, required for vehicles of certain weight classes or heavily loaded vehicles. By this means, an almost constant natural frequency of the structure can be ensured, and this increases driving safety. With a multi-leaf structure of a leaf spring made from a fiber-plastic composite, in particular a glass-fiber plastic, there is a risk of damage due, for example, to the penetration of dirt particles and/or to abrasion between the leaves of the leaf spring. Thus, increasing the rigidity and/or producing a rising-rate suspension in a multi-leaf leaf spring made from a fiber-plastic composite, in particular a glass-fiber composite, is no simple matter to achieve.

### SUMMARY OF THE INVENTION

The purpose of the present invention is to develop further a leaf spring holder and/or a chassis of the type mentioned to begin with, in such manner that as a function of the spring deflection the rigidity is increased and/or a rising-rate suspension can be achieved. In particular, an alternative embodiment should be provided.

The objective addressed by the invention is achieved with a leaf spring holder according to Claim the claims by means of a chassis according to the claims. Preferred further developments of the invention emerge from the subordinate claims and from the description given below.

The leaf spring holder is designed to connect a leaf spring to an axle. In this context the axle can be in the form of a rigid axle and/or a wheel axle. In particular, the axle extends transversely or perpendicularly to a longitudinal axis of the vehicle. The leaf spring holder comprises a first fixing device and a second fixing device. In this case the first fixing device co-operates with the second fixing device. By virtue of this co-operation a first mounting and a second mounting some distance away from the first mounting are produced. By virtue of the first mounting and the second mounting, the leaf spring is or can be fitted between the first fixing device and the second fixing device. In particular, owing to the first mounting and the second mounting, the leaf spring is connected fast to the leaf spring holder. Preferably, owing to the fitting of the leaf spring onto the leaf spring holder the leaf spring is held firmly and cannot move relative to the leaf spring holder and in the direction of the length of the leaf spring. The first fixing device and the second fixing device are designed such that by virtue of the co-operation between the first and second fixing devices, a deformation of a leaf spring section of the leaf spring is enabled. This leaf spring section of the leaf spring is located between the first mounting and the second mounting. In particular, the leaf spring section is located between the first fixing device and the second fixing device. The leaf spring holder has a stop surface to limit the deformation of the leaf spring section.

Here it is advantageous that owing to the stop surface that limits the deformation of the leaf spring section, the elastic properties of the leaf spring can be varied as a function of the spring deflection and/or a spring load.

A deformation is understood to mean a torsion and/or a bending deformation. The deformation can be elastic. In particular, the deformation is directed transversely or perpendicularly to the longitudinal extension of the leaf spring. Preferably, the deformation takes place in a plane in which both the first fixing device and the second fixing device are located.

By virtue of the first mounting and the second mounting, the leaf spring, particularly in an unloaded condition, is connected to the axle not centrally but eccentrically. Because of this the leaf spring, in particular the leaf spring section, can deform between the two mountings, preferably by bending. In particular, during a compression movement, the distance of the leaf spring section from the stop surface decreases until the leaf spring section finally comes into contact with the stop surface and any further deformation, in particular bending of the leaf spring, is prevented or blocked. Thus, an effective segment length of the leaf spring and/or an elastic part of the leaf spring can be reduced.

The unloaded condition of the leaf spring can relate to an unfitted condition of the leaf spring holder relative to its fitting in a chassis and/or vehicle. Alternatively, the unloaded condition of the leaf spring can relate to a condition of the leaf spring holder as fitted into a vehicle and/or chassis, such that a spring load acts upon the leaf spring which corresponds at most to the spring load in an empty or unloaded condition of the vehicle, or is below a specified spring load.

Preferably, by means of the stop surface a suspension that increases the rigidity of the leaf spring and/or a rising-rate suspension can be or is produced. In particular, by virtue of the stop surface the deformation of the leaf spring section between the first fixing device and the second fixing device and/or in a direction transverse to the longitudinal extension of the leaf spring section is limited.

In a further development, the co-operation of the first fixing device and the second fixing device enables the leaf spring section to deform up to a predetermined spring load. In particular, a spring load brings about a spring deflection and/or a jouncing movement of the leaf spring. Owing to the jouncing movement, in particular until the predetermined spring load has been reached, the leaf spring section is deformed away from the first fixing device in the direction of the second fixing device, in particular being bent. Preferably, any further deformation of the leaf spring section under the action of a spring load that corresponds to the predetermined spring load and/or which is higher than the predetermined spring load, is blocked and/or prevented by the stop surface. In particular, the spring loading acts starting from the axle and/or the first fixing device in the direction toward the second fixing device.

According to a further embodiment, the leaf spring section extends between the first mounting and the second mounting. Thus, the leaf spring can be clamped on the first mounting and/or the second mounting between the first fixing device and the second fixing device. In particular, the first fixing device and/or the second fixing device is/are U-shaped. Then, the arms of the U-shapes of the two fixing devices can face toward one another and can serve to form the two mountings. Preferably, the first fixing device and/or the second fixing device is/are made rigid and/or inelastic, in particular essentially so. The first and/or the second mounting comprise(s) an elastomer support. Thus, the leaf spring can be clamped between the first fixing device and the second fixing device with interposition of an elastomer support. The elastomer support can assist and/or enable a rotation and/or translation movement of the leaf spring and/or the leaf spring section in the area of the first or the second mounting. The elastomer support can in each case have a first elastomer layer and at least one further elastomer layer. In particular, the first elastomer layer is arranged between the leaf spring and the first fixing device. Then, the first elastomer layer is in contact with the first fixing device on one side and with the leaf spring on the other side. The further elastomer layer can be arranged between the leaf spring and the second fixing device. Thus, the further elastomer bearing can be in contact with the leaf spring on one side and with the second fixing device on the other side. By virtue of the elastomer support any penetration and/or any damage due to dirt particles and/or abrasion in the area of the first mounting or the second mounting is prevented.

In a further development, the leaf spring has at least one portion of thickened material to prevent any slipping of the leaf spring in the direction of its length. Thus, the leaf spring can have one or more sections which are made thicker than the areas away from the thickened material. Preferably, the aforesaid leaf spring section is a thickened area. In particular, owing to the thickened material the leaf spring section is thicker than a section of the leaf spring in the area of the first mounting and/or the second mounting. In particular, the thickened material extends transversely and/or perpendicularly to the length of the leaf spring. In a fitted condition of the leaf spring holder in a vehicle, the thickened material can extend in the vertical direction. Preferably, the thickened material abuts against the first mounting and/or the second mounting. Owing to the form of the leaf spring section as a thicker material, slipping of the leaf spring in the direction of the length of the leaf spring under the action of longitudinal forces can be prevented. In this connection the first mounting and/or the second mounting can serve in effect as a stop for the leaf spring section. Alternatively or in addition to the formation of the leaf spring section as a thickened material, a section of the leaf spring that abuts against the first mounting and/or the second mounting can be formed of thickened material, these sections being arranged outside the two fixing devices. In particular the sections of thickened material extend between the first mounting and the adjacent, first axial end of the leaf spring and between the second mounting and the adjacent, second axial end of the leaf spring. Preferably, in the area of the first mounting and/or of the second mounting the leaf spring has a thinner portion, by virtue of which slipping of the leaf spring in the direction of its length can be prevented and/or blocked.

According to a further development, the first fixing device is designed for fixing the leaf spring holder to the axle. The first fixing device can be attached to the first axle by means of an interlocking, frictional and/or material-merged joint. Preferably, any movement of the axle relative to the first fixing device is excluded or prevented. In a fitted condition the first fixing device can be arranged above the axle. Preferably, any movement of the second fixing device relative to the first fixing device and/or the axle is also excluded. In particular, the stop surface is associated with the second fixing device. Thus, the stop surface can be made as an integral part of the second fixing device. Preferably, the stop surface faces toward the first fixing device and/or the leaf spring section. In a fitted condition the second fixing device can be arranged above the first fixing device.

Preferably, the stop surface is arranged between the first mounting and the second mounting. Thus, the stop surface can extend from the first mounting to the second mounting. In particular the stop surface can extend in the direction of the length of the leaf spring and/or the leaf spring section. The stop surface can be flat, curved, and made in one piece or more than one piece. For example the stop surface can be curved in a convex or concave manner. Furthermore, the stop surface, the first fixing device and/or the second fixing device can be made of metal.

According to a further development, the second fixing device can comprise a bridge element. The stop surface can be associated with the bridge element, or the bridge element can comprise the stop surface. In particular, the stop surface is arranged on one side of the bridge element extending from the first mounting to the second mounting. Correspondingly, the bridge element can extend in the direction of the length of the leaf spring and/or the leaf spring section. In particular, the bridge element is made substantially rigid. Preferably, the second fixing device is connected to the first fixing device by means of at least one holding element, preferably two holding elements. Thus, the first fixing element can be connected to the second fixing element specifically by means of one holding element or two holding elements. The holding element can be in the form of a clamp. Moreover, the holding element can be made of metal or plastic. Preferably the holding element is U-shaped. By means of an interlocking, frictional and/or material-merged joint the holding element can be connected to the first fixing device. The first fixing device can have recesses which enable the holding element to be held or fastened on. Furthermore, the holding element can co-operate with the second fixing device in an interlocked manner. For this, the holding element can grip the second fixing device with interlock and/or the holding element is plugged onto and/or around the second fixing device. In that case, free ends of the holding element can extend toward the first fixing device and/or through the latter.

In a further embodiment, on a side of the leaf spring facing toward the stop surface an elastomer layer is arranged. In particular the elastomer layer is attached firmly to the side of the leaf spring section that faces toward the stop surface, for example by adhesive bonding or vulcanizing. The elastomer layer can be made of a rubber material. In particular, the elastomer layer extends between the first mounting and the second mounting. By virtue of the elastomer layer the side of the leaf spring section facing toward the stop surface is protected against dirt particles and/or abrasion. The elastomer layer can have a constant thickness over its full extension. Alternatively, the elastomer layer can have a concave or convex curvature. In addition, the elastomer layer can consist of one, or of several layers. In an alternative embodiment the elastomer layer can be limited to one or more sections of the side of the leaf spring section facing toward the stop surface. According to another alternative, the elastomer layer can be arranged on the side of the stop surface facing toward the leaf spring section. In this case the elastomer layer can be attached firmly to the side of the stop surface facing toward the leaf spring section, for example by adhesive bonding or vulcanizing. Depending on the structure of the stop surface and/or that of the elastomer layer, the dependence of the rigidity of the leaf spring on the spring load and/or on a spring deflection can be adjusted according to need.

Preferably, the leaf spring is made of a plastic material, in particular a fiber-reinforced plastic or a glass-fiber plastic. In particular, the leaf spring is in the form of a fiber-plastic composite. The leaf spring can be a single-leaf spring. Owing to the top surface for limiting the deformation of the leaf spring section, even with a single-leaf spring or leaf spring with one leaf the rigidity can be increased, particularly above a specified spring load. In that way, compared with a multi-leaved leaf spring weight can be saved. Preferably, the leaf spring is a longitudinal leaf spring. Particularly in a fitted condition of the leaf spring and/or leaf spring holder in a vehicle, the longitudinal leaf spring extends in the longitudinal direction of the vehicle.

According to a further development, in a first operating mode below a specified spring load the leaf spring section can be deformed in the direction toward the stop surface. In particular, in the first operating mode a free space is left between the stop surface and the leaf spring section. Preferably, the free space is located between the stop surface and the elastomer layer attached to the leaf spring section and facing toward the stop surface. In the first operating mode the leaf spring section can deform into the free space until the specified spring loading is reached.

Preferably, in a further operating mode when a specified spring load has been reached or exceeded, the further deformation of the leaf spring section toward the stop surface is blocked. In particular, in this further operating mode the leaf spring section is partially or fully in contact with the stop surface. Preferably, in the further operating mode the elastomer layer attached to the leaf spring section and facing toward the stop surface is partially or fully in contact with the stop surface.

In particular, a rigidity of the leaf spring is lower in the first operating mode than in the further operating mode. Thus, the rigidity can be changed and/or increased as a function of the spring load and/or the spring deflection. In particular, in that way rising-rate suspension can be achieved. The specified spring load for changing between the first operating mode and the further operating mode can be adjusted by means of a stop surface, a leaf spring section and/or an elastomer layer facing the stop surface, respectively formed according to need. For this, the form of the stop surface, leaf spring section and/or elastomer layer can be realized by means of the design of its contour.

Of particular advantage is a chassis with a leaf spring holder according to the invention, wherein the leaf spring holder connects a leaf spring to an axle. In particular, in this a rigidity of the leaf spring in a first operating mode is lower than in a further operating mode. The leaf spring holder and/or the chassis can be provided for a vehicle, especially a motor vehicle, and/or built into a vehicle, especially a motor vehicle.

Preferably, in the area of the leaf spring holder in the first operating mode a two-point mounting of the leaf spring is realized. By virtue of the first mounting and the second mounting of the leaf spring holder and the possibility of deforming the leaf spring section in the first operating mode between the first mounting and the second mounting, the two-point mounting of the leaf spring in the area of the leaf spring holder is realized.

For the leaf spring as a whole, in the first operating mode a four-point mounting or a five-point mounting can be produced. In particular, a first axial end of the leaf spring and a second axial end of the leaf spring remote from the first axial end can be mounted on a vehicle frame, a vehicle body and/or an intermediate element. In that way, at the same time two in particular outer mounting points for the leaf spring are provided. The intermediate element can be in the form of a shackle.

In particular, in the further operating mode a one-point mounting in the area of the leaf spring holder is produced. Owing to the contact between the leaf spring section and the stop surface in the further operating mode, the co-operation of the leaf spring section with the leaf spring holder acts as a single further mounting point. In that way, in the further operating mode the one-point mounting is realized in the area of the leaf spring.

For the leaf spring as a whole, in the further operating mode a three-point mounting or a four-point mounting can be produced. Preferably, in the further operating mode a mounting with one mounting point fewer than in the first operating mode is produced. In that way, by virtue of the two axial ends of the leaf spring and their mounting on the vehicle frame or vehicle body, two mounting points are obtained.

Thus, owing to the stop surface and considering only the area of the leaf spring holder, a change between a two-point mounting and a one-point mounting of the leaf spring is enabled.

Preferably, the leaf spring holder is developed further in accordance with all the design features explained in connection with the chassis according to the invention described here. Furthermore, the chassis described here can be developed further in accordance with all the design features explained in connection with the leaf spring holder.

### BRIEF DESCRIPTION OF THE DRAWINGS

Below, the invention is explained with reference to the figures. In this, the same indexes refer to the same, similar, or functionally equivalent components or elements. The figures show:

FIG. 1: A side view of a leaf spring holder according to the invention, in a first operating mode,

FIG. 2: A first cross-section of the leaf spring holder according to the invention, shown in FIG. 1,

FIG. 3: A further cross-section of the leaf spring holder according to the invention, shown in FIG. 1,

FIG. 4: A side view of a leaf spring holder according to the invention, in a further operating mode,

FIG. 5: A first cross-section of the leaf spring holder according to the invention, shown in FIG. 4,

FIG. 6: A further cross-section of the leaf spring holder according to the invention, shown in FIG. 4.

### DETAILED DESCRIPTION OF THE DRAWINGS

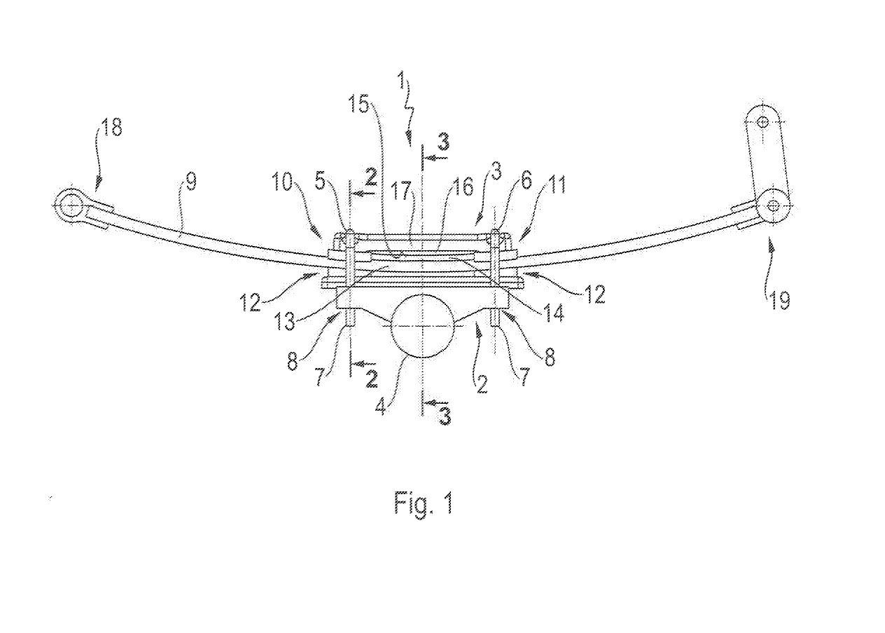

FIG. 1 shows a side view of a leaf spring holder 1 according to the invention, in a first operating mode. The leaf spring holder 1 comprises a first fixing device 2 and a second fixing device 3. The first fixing device 2 is connected to an axle 4. In this example embodiment the axle 4 is a rigid axle. In a condition (not illustrated in detail here) as fitted in a vehicle, the axle 4 extends transversely or perpendicularly to the longitudinal direction or travel direction of the vehicle. Owing to the connection of the axle 4 to the first fixing device 2, movement of the axle 4 relative to the first fixing device 2 is excluded. The connection between the axle 4 and the first fixing device 2 can for example be in the form of a welded joint or a bolted joint. In this example embodiment the first fixing device 2 is positioned above the axle 4.

The first fixing device 2 is connected to the second fixing device 3. Here, the second fixing device 3 is positioned above the first fixing device 2. To connect the first fixing device 2 to the second fixing device 3, the leaf spring holder 1 has holding elements 5, 6. In this example embodiment the holding elements 5, 6 are in the form of U-shaped clamps. The arms of the holding elements 5, 6 engage the second fixing device 3 with interlock and extend in the direction of the first fixing device 2. The holding elements 5, 6 have free ends 7. The free ends 7 of the holding elements 5, 6 on the arms of the U-shaped holding elements 5, 6 extend in this example embodiment through correspondingly formed apertures 8 in the first fixing device 2. In this example embodiment the apertures 8 are in the form of through-holes or bores. By means of a suitable connection, for example a weld joint or bolted joint, the holding elements 5, 6 are attached to the first fixing device 2. The holding elements 5, 6 are arranged in the area of two ends of the leaf spring holder 1 a distance apart from one another. Furthermore, the holding elements 5, 6 are separated from one another in the direction of the length of a leaf spring 9. The leaf spring 9 is held or arranged between the first fixing device 2 and the second fixing device 3. In this example embodiment the leaf spring 9 is in the form of a longitudinal leaf spring. In addition, in this embodiment the leaf spring 9 is made of a fiber-plastic composite, namely a glass-fiber plastic. Moreover, the leaf spring 9 is a single-leaf or one-leaved spring.

Owing to the co-operation of the first fixing device 2 with the second fixing device 3, a first mounting 10 and a second mounting 11 are formed. The first mounting 10 and the second mounting 11 are a distance apart form one another and are designed to hold the leaf spring 9 between the first fixing device 2 and the second fixing device 3. Here, the first mounting 10 is arranged in the area of the holding element 5 and the second mounting 11 in the area of the holding element 6. The first mounting 10 and the second mounting 11 are designed mirror-symmetrically to one another. Alternatively, the two mountings 10, 11 can be different distances away from the axis 4. The first mounting 10 and the second mounting 11 each comprise an elastomer fitting 12. The elastomer fitting 12 will be explained in greater detail with reference to the figures below.

The leaf spring 9 has a leaf spring section 13. This leaf spring section 13 is arranged between the first mounting 10 and the second mounting 11. In this example embodiment the leaf spring section 13 has at least one area of thickened material, so that the leaf spring section 13 is thicker than a section of the leaf spring 9 in the area of the two mountings 10, 11 and/or outside the leaf spring section 13. Here, the thickened material in this example extends in the vertical direction. In addition the thickened material or leaf spring section 13 abuts against the elastomer fitting 12 of the first mounting 10 on one side and against the elastomer fitting 12 of the second mounting 11 on the other side. This prevents or blocks any slipping of the leaf spring 9 or leaf spring section 13 in the direction of the length of the leaf spring 9.

On a side facing toward the second fixing device 3, the leaf spring section 13 has an elastomer layer 14. In this example embodiment the elastomer layer 14 extends from the first mounting 10 to the second mounting 11. Here, the elastomer layer is in contact on one side against the elastomer fitting 12 of the first mounting 10 and on the other side against the elastomer fitting 12 of the second mounting 11. In this embodiment variant the elastomer layer 14 has a constant thickness all over its length. The elastomer layer 14 is attached firmly to the side of the leaf spring section 13 facing toward a stop surface 15.

The second fixing device 3 has a stop surface 15. The stop surface 15 faces toward the leaf spring section 13 and the elastomer layer 14. In the first operating mode illustrated here there is a free space between the stop surface 15 and the leaf spring section 13 and its elastomer layer 14.

The second fixing device 3 comprises a bridge element 17. The bridge element 17 extends from the first mounting 10 to the second mounting 11. The stop surface 15 is arranged on one side of the bridge element 17 facing toward the first fixing device 2.

The leaf spring 9 has a first axial end 18 and a second axial end 19 remote from the first axial end 18. By means of the two axial ends 18, 19 the leaf spring 9 can be fitted onto a vehicle frame or vehicle body (not shown here). Thus, in the first operating mode the leaf spring 9 is, on the one hand, mounted in the area of the first axial end 18 and in the area of the second axial end 19. In addition, the leaf spring 9 is held in the area of the first mounting 10 and the second mounting 11. Thus, in relation to the leaf spring holder 1 a two-point mounting of the leaf spring 9 is produced in the first operating mode.

In this example embodiment, the first axial end 18 can be connected and articulated directly to a vehicle frame or vehicle body. The second axial end 19 can in this case be connected to a vehicle frame or vehicle body by way of an intermediate element. The intermediate element can be designed as a so-termed shackle. A first end of the intermediate element is articulated to the second axial end 19. A second end of the intermediate element a distance away from its first end can be articulated to a vehicle frame or vehicle body. By means of the intermediate element a change of the length of the leaf spring 9 during compression and/or extension movements can be compensated.

When the axle 4 is pressed up in the vertical direction, the leaf spring section 13 is deformed between the first mounting 10 and the second mounting 11. Specifically, during this the leaf spring section 13 between the first mounting 10 and the second mounting 11 is bent up toward the stop surface 15. Here, the deformation or bending of the leaf spring section 13 takes place into the area of the free space 16.

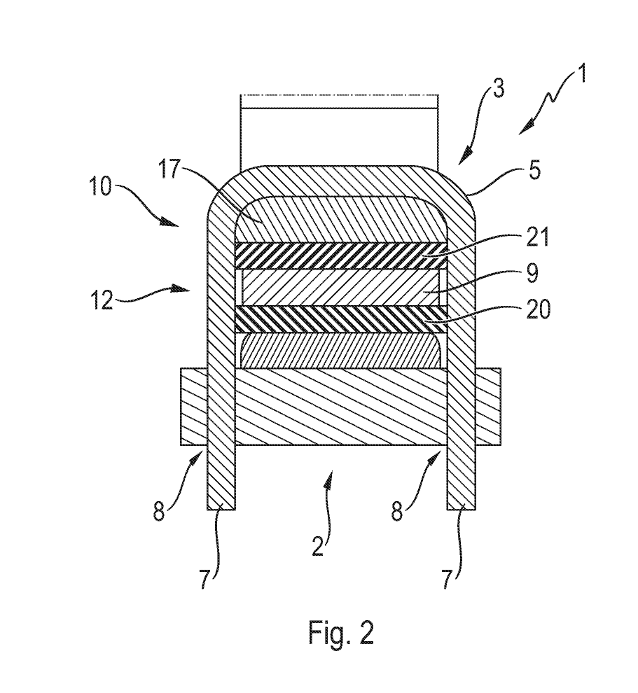

FIG. 2 shows a first cross-section 2-2 through the leaf spring holder 1 according to the invention shown in FIG. 1. In this example embodiment the elastomer fitting 12 comprises a first elastomer layer 20 and a further elastomer layer 21. The first elastomer layer 20 is arranged between the leaf spring 9 and the first fixing device 2. Thus, the first elastomer layer 20 is in contact with the leaf spring 9 on one side and with a side or surface of the first fixing device 2 on its other side. The further elastomer layer 21 is arranged between the leaf spring 9 and the second fixing device 3. Thus, the further elastomer layer 21 is in contact with the leaf spring 9 on one side and with a side or surface of the second fixing device 3 on its other side. Thanks to this layering, damage-free deformation of the leaf spring 9 in the area of the first mounting 10 and the same in the area of the second mounting 11 is possible.

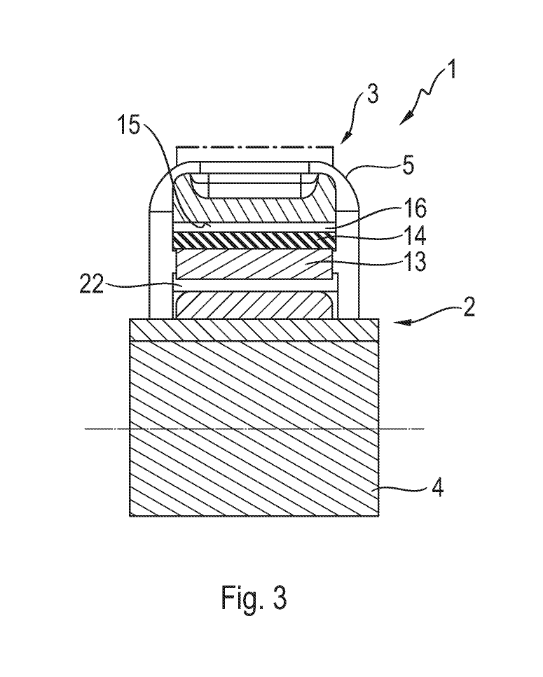

FIG. 3 shows a further cross-section 3-3 of the leaf spring holder 1 shown in FIG. 1. The free space 16 between the stop surface 15 and the elastomer layer 14 can be seen clearly. In the first operating mode, under the action of spring loading and until a specified spring load is reached, the leaf spring section 13 can deform or bend into the area of the free space 16.

On a side facing away from the stop surface 15 or the elastomer layer 14, a free space 22 is formed between the leaf spring section 13 and the first fixing device 2. As shown in FIG. 1 this free space 22 extends from the first mounting 10 to the second mounting 11. Specifically, the free space 22 extends between the elastomer layer 12 of the first mounting 10 and the elastomer layer 12 of the second mounting 11. When the leaf spring section 13 deforms in the direction of the stop surface 15, the free space 22 becomes larger. In particular, the distance between the leaf spring section 13 and the first fixing device 2 becomes larger.

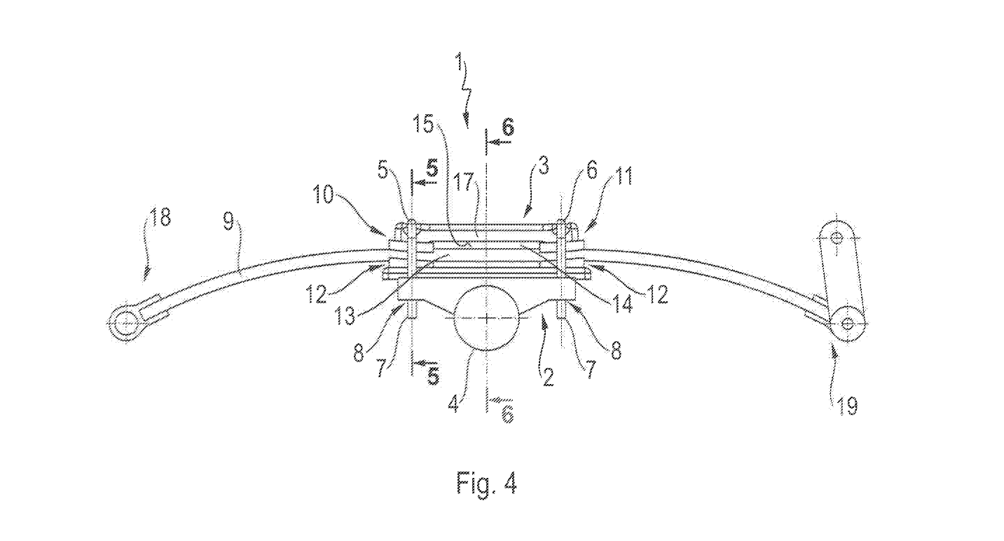

FIG. 4 shows a side view of the leaf spring holder 1 according to the invention in a further operating mode. In this further operating mode the leaf spring section 13 is deformed or bent in such manner that the leaf spring section 13, or in this example embodiment the elastomer layer 14, comes in contact with the elastomer layer 14 on the stop surface 15. Thus, in the further operating mode the free space present in FIGS. 1 to 3 is no longer there, or has been bridged or filled, owing to the deformation of the leaf spring section 13.

In the further operating mode, moreover, in relation to the leaf spring holder 1 the leaf spring 9 is held in a one-point mounting. Thus, in the further operating mode the leaf spring holder 1 provides a single holding point. In addition, as in the first operating mode at least one further mounting point is formed at each of the two axial ends 18, 19.

Comparing the further operating mode as in FIG. 4 and the first operating mode as in FIGS. 1 to 3, it can be seen that the effective length of the leaf spring 9 or the elastic portion of the leaf spring 9 is reduced. Since owing to its contact against the stop surface 15 the leaf spring section 13 is prevented from further deformation, the rigidity of the leaf spring 9 is greater in the further operating mode than it is in the first operating mode.

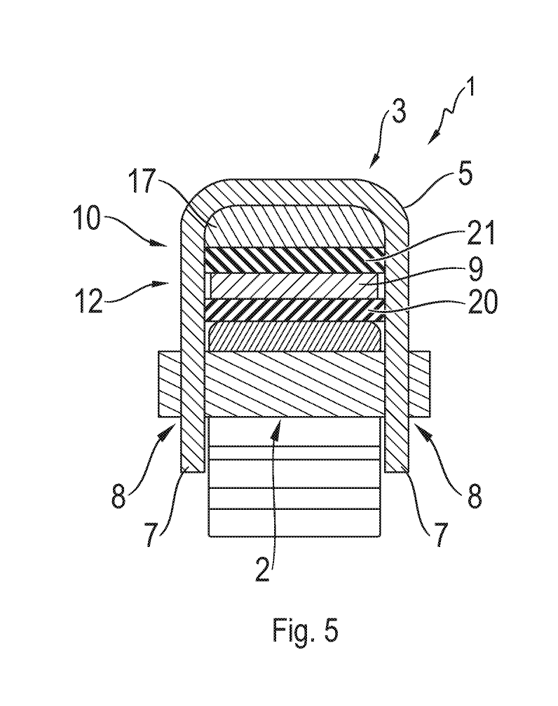

FIG. 5 shows a cross-section 5-5 through the leaf spring holder 1 according to the invention shown in FIG. 4. The structure of this cross-section corresponds essentially to the structure shown in FIG. 2. Thus, reference can be made to the previous description.

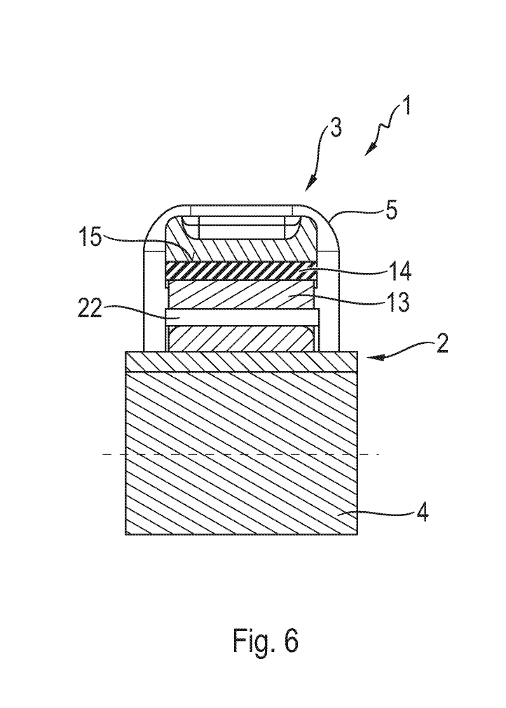

FIG. 6 shows a further cross-section 6-6 through the leaf spring holder 1 according to the invention shown in FIG. 4. It can be seen that the elastomer layer 14 is in contact with the stop surface 15 all over its surface, so the free space 16 shown in FIG. 3 has been fully bridged or filled in the further operating mode illustrated here. Furthermore, the distance between the leaf spring section 13 and the first fixing device 2, and hence the free space 22, is larger in the further operating mode compared with the first operating mode according to FIG. 3.

### INDEXES

1 Leaf spring holder
2 First fixing device
3 Second fixing device
4 Axle
5 Holding element
6 Holding element
7 Free end
8 Aperture
9 Leaf spring
10 First mounting
11 Second mounting
12 Elastomer support
13 Leaf spring section
14 Elastomer layer
15 Stop surface
16 Free space
17 Bridge element
18 First axial end
19 Second axial end
20 First elastomer layer
21 Further elastomer layer
22 Free space

1-15. (canceled)

16. A leaf spring holder for connecting a leaf spring (9) to an axle (4), by a first fixing device (2) and a second fixing device (3),
due to co-operation of the first fixing device (2) with the second fixing device (3), a first mounting (10) and a second mounting (11), a distance away from the first mounting (10), being realized for mounting the leaf spring (9) between the first fixing device (2) and the second fixing device (3), and
the co-operation of the first fixing device (2) with the second fixing device (3) facilitating deformation of a leaf spring section (13) of the leaf spring (9) between the first mounting (10) and the second mounting (11), and a stop surface (15) for limiting the deformation of the leaf spring section (13).

17. The leaf spring holder according to claim 16, wherein by virtue of the stop surface (15), at least one of an elasticity and a progressive suspension that increases the rigidity of the leaf spring (9) is produced, by way of the stop surface (15), the deformation of the leaf spring section (13) is restricted, at least one of between the first fixing device (2) and the second fixing device (3) and in a direction transverse to a length of the leaf spring section (13).

18. The leaf spring holder according to claim 16, wherein the co-operation of the first fixing device (2) with the second fixing device (3) facilitates deformation of the leaf spring section (13) up to a specified spring load such that, under action of a spring load that is at least one of equal to and greater than the specified spring load, the stop surface (15) blocks further deformation of the leaf spring section (13).

19. The leaf spring holder according to claim 16, wherein the leaf spring section (13) extends between the first mounting (10) and the second mounting (11), and the leaf spring section (13) is clamped, with an interposition of an elastomer support (12), between the first fixing device (2) and the second fixing device (3).

20. The leaf spring holder according to claim 16, wherein the leaf spring (9) has a portion of thickened material for preventing slippage of the leaf spring (9) in a direction of a length of the leaf spring (9), and the leaf spring section (13) is in a form of the thickened material portion so that due to the thickened material, the leaf spring section (13) is thicker than parts of the leaf spring (9) away from the leaf spring section (13), and the thickened material extends at least one of transversely to a length of the leaf spring (9) and in a vertical direction when the leaf spring holder (1) is fitted in a vehicle.

21. The leaf spring holder according to claim 16, wherein the first fixing device (2) is configured to fasten the leaf spring holder (1) to the axle (4) and the stop surface (15) is associated with the second fixing device (3), and the stop surface (15) faces toward at least one of the first fixing device (2) and the leaf spring section (13).

22. The leaf spring holder according to claim 16, wherein the stop surface (15) is arranged between the first mounting (10) and the second mounting (11), and the stop surface (15) extends from the first mounting (10) to the second mounting (11).

23. The leaf spring holder according to claim 16, wherein the stop surface (15) is arranged on one side of a bridge element (17) of the second fixing device (3) that extends from the first mounting (10) to the second mounting (11), and the bridge element (17) is connected by at least one holding element (5, 6) to the first fixing device (2), and the holding elements (5, 6) are associated, respectively, with the first mounting (10) and with the second mounting (11).

24. The leaf spring holder according to claim 16, wherein an elastomer layer (14) is arranged on at least one of a side of the leaf spring section (13) facing toward the stop surface (15) and a side of the stop surface (15) facing toward the leaf spring section (13), and the elastomer layer (14) extends between the first mounting (10) and the second mounting (11).

25. The leaf spring holder according to claim 16, wherein the leaf spring (9) is made of at least one of a plastic material, a fiber-reinforced plastic, and a glass-fiber plastic, and the leaf spring (9) is in a form of at least one of a single-leaf spring and a longitudinal leaf spring.

26. The leaf spring holder according to claim 16, wherein the leaf spring section (13) is, in a first operating mode below a specified spring load, deformable in a direction toward the stop surface (15), and, in the first operating mode, there is a free space (16) between the stop surface (15) and either the leaf spring section (13) or an elastomer layer (14) arranged on the leaf spring section (13) facing toward the stop surface (15).

27. The leaf spring holder according to claim 16, wherein deformation of the leaf spring section (13) hi a direction of the stop surface (15) is blocked, in a further operating mode, when a specified spring load has been at least one of reached and exceeded, and, in the further operating mode, either the leaf spring section (13) or an elastomer layer (14) arranged on the leaf spring section (13) facing toward the stop surface (15) is either partially or fully in contact with the stop surface (15).

28. The leaf spring holder according to claim 27, wherein a rigidity of the leaf spring (9) is lower in the first operating mode than in a further operating mode, and the specified spring load is adjustable by at least one of the stop surface (15) designed according to need, the leaf spring section (13) designed according to need, and the elastomer layer (14) designed according to need and facing toward the stop surface (15).

29. A chassis with a leaf spring holder which connects a leaf spring (9) to an axle (4), with a first fixing device (2) and a second fixing device (3),
due to co-operation of the first fixing device (2) with the second fixing device (3), a first mounting (10) and a second mounting (11), a distance away from the first mounting (10), are realized for mounting the leaf spring (9) between the first fixing device (2) and the second fixing device (3), and
the co-operation of the first fixing device (2) with the second fixing device (3) facilitates deformation of a leaf spring section (13) of the leaf spring (9) between the first mounting (10) and the second mounting (11), and
a stop surface (15) for limiting the deformation of the leaf spring section (13),
a rigidity of the leaf spring (9), in a first operating mode, is lower than a rigidity of the leaf spring (9), in a further operating mode.

30. The chassis according to claim 29, wherein, in the first operating mode, a two-point mounting of the leaf spring (9) is produced in an area of the leaf spring holder (1), and, in the further operating mode, a single-point mounting of the leaf spring (9) is produced, and
a first axial end (18) of the leaf spring (9) and a second axial end (19) of the leaf spring (9), remote from the first axial end (18), are mounted on one of a vehicle frame, a vehicle body and an intermediate element.

31. A leaf spring holder for connecting a leaf spring to an axle, the leaf spring holder comprising a first fixing device and a second fixing device which together form a first mounting and a second mounting, the second mounting being spaced a distance away from the first mounting, the first and the second mountings supporting the leaf spring between the first fixing device and the second fixing device, the first and the second fixing devices facilitating deformation of a leaf spring section of the leaf spring between the first mounting and the second mounting, a stop surface limiting the deformation of the leaf spring section.
